(19) United States
(12) Patent Application Publication
(10) Pub. No.: US 2024/0174037 A1
(43) Pub. Date: May 30, 2024

(54) TRAILER TOW CONNECTOR

(71) Applicant: STONERIDGE, INC., Novi, MI (US)

(72) Inventors: Cesar Gerardo Ramos Martinez, Juarez (MX); Luis Fernando Casillas Collazo, Juarez (MX)

(21) Appl. No.: 18/525,340

(22) Filed: Nov. 30, 2023

Related U.S. Application Data
(60) Provisional application No. 63/428,906, filed on Nov. 30, 2022.

(51) Int. Cl. B60D 1/64; H01R 13/447

(52) U.S. Cl. CPC B60D 1/64; H01R 13/447

(57) ABSTRACT

A trailer tow connector for a vehicle used in towing a trailer includes a housing that has first and second bodies that respectively provide first and second electrical connections. The housing has laterally spaced apart hinge posts. A spring is arranged relative to first and second covers. The first cover has a central hinge portion, and the second cover has lateral hinge portions, the first and second covers respectively over the first and second bodies. Lateral hinge portions are arranged laterally outside the hinge posts, and the lateral hinge portions provide a portion of an aesthetic perimeter, the portion conceals outer sides of the hinge posts. A pin extends through a hole in at least one lateral hinge portion, and through the central hinge portion, the hinge posts and the spring.

### CROSS-REFERENCE TO RELATED APPLICATION

This application claims priority to U.S. Provisional Application No. 63/428,906 filed Nov. 30, 2022.

### TECHNICAL FIELD

This disclosure relates to a trailer tow connector for a tow vehicle.

### BACKGROUND

Various systems from a trailer must be connected to a tow vehicle, such as a passenger truck. Conventionally either one of a combination 4-way and 7-way trailer tow connector is removably connected to a corresponding trailer connector. This enables the trailer's parking brake lights, turn signals, and brake lights to be operated in unison with the vehicle's lights. In the case of a 7-way connector, the vehicle may also operate electric trailer brakes through the trailer tow connector and trailer connect junction. There are also trailer tow connectors with other types of electrical connectors.

It is desirable to keep the trailer tow connector's electrical connections free from water, salt, dirt and other debris when not in use to prevent corrosion. To this end, a spring-biased hinged cover is provided over each electrical connection to cover the electrical connector. Despite this approach, water and debris may still reach the electrical connections.

### SUMMARY

In one exemplary embodiment, a trailer tow connector for a vehicle used in towing a trailer includes a housing that has first and second bodies that respectively provide first and second electrical connections. The housing has laterally spaced apart hinge posts. A spring is arranged relative to first and second covers. The first cover has a central hinge portion, and the second cover has lateral hinge portions, the first and second covers respectively over the first and second bodies. Lateral hinge portions are arranged laterally outside the hinge posts, and the lateral hinge portions provide a portion of an aesthetic perimeter, the portion conceals outer sides of the hinge posts. A pin extends through a hole in at least one lateral hinge portion, and through the central hinge portion, the hinge posts and the spring.

In a further embodiment of any of the above, the housing provides an outer perimeter wall that is configured to abut a structure with the trailer tow connector in an installed position. The aesthetic perimeter is provided by the first and second covers. The aesthetic perimeter substantially conceals the outer perimeter wall with the first and second covers in a closed position.

In a further embodiment of any of the above, the first and second covers and the hinge posts provide an exterior aesthetic face that substantially covers the spring. The aesthetic perimeter is provided by the first and second covers and circumscribes the exterior aesthetic face.

In a further embodiment of any of the above, the spring is provided by spaced apart coils, a terminal end that extends from each coil in a first direction and received in a first pocket in the first cover, and a closed portion that joins the coils and extends in a second direction opposition the first direction. The closed portion has a closed end received in a second pocket in the second cover. The pin extends through the coils.

In a further embodiment of any of the above, the first and second covers and the hinge posts provide an exterior aesthetic face generally in a plane. The terminal ends and the closed end are generally parallel to the plane and are respectively spaced at first and second distances orthogonal to the plane. The first and second distances are different than one another.

In a further embodiment of any of the above, the first distance is less than the second distance, and the closed portion is U-shaped.

In a further embodiment of any of the above, the trailer tow connector includes a plane transverse to a longitudinal axis of the pin, and the spring is generally Z-shaped from a view toward the plane.

In a further embodiment of any of the above, the first electrical connection is a 4-pin connector, and the second electrical connection is a 7-pin connector.

In a further embodiment of any of the above, the pin includes first, second and third sections along a longitudinal axis of the pin. The second section is longitudinally between the first and third sections. The second section has a diameter greater than that of the first and third sections, the second section is retained in the hole of the at least one lateral hinge portion in an interference fit.

In a further embodiment of any of the above, a vehicle that includes the trailer tow connector includes a structure that has an aperture that receives the housing. The housing has a first end on a first side of the structure and includes the first and second bodies. The aesthetic perimeter provides an outermost perimeter of the trailer tow connector around an entire periphery of the trailer tow connector on the first side.

In a further embodiment of any of the above, the housing has a second end opposite the first end and is arranged on a second side of the structure opposite the first side. The second end provides an electrical connector that is connected to a wiring harness of the vehicle.

In another exemplary embodiment, a method of assembling a trailer tow connector includes providing a housing that has first and second bodies that respectively provide first and second electrical connections. The housing has laterally spaced apart hinge posts. A spring is arranged relative to first and second covers. The first cover has a central hinge portion, and the second cover has lateral hinge portions. The first and second covers are positioned respectively over the first and second bodies. Lateral hinge portions are arranged laterally outside the hinge posts, and the lateral hinge portions provide a portion of an aesthetic perimeter. The portion conceals outer sides of the hinge posts. A pin is inserted through a hole in at least one lateral hinge portion, and the inserting step includes inserting the pin through the central hinge portion, the hinge posts and the spring.

In a further embodiment of any of the above, the housing provides an outer perimeter wall that is configured to abut a structure with the trailer tow connector in an installed position. The aesthetic perimeter is provided by the first and second covers. The aesthetic perimeter substantially conceals the outer perimeter wall with the first and second covers in a closed position.

In a further embodiment of any of the above, the first and second covers and the hinge posts provide an exterior aesthetic face that substantially covers the spring. The aesthetic perimeter is provided by the first and second covers and circumscribes the exterior aesthetic face.

In a further embodiment of any of the above, the spring is provided by spaced apart coils, a terminal end that extends from each coil in a first direction and received in a first pocket in the first cover, and a closed portion that joins the coils and extends in a second direction opposition the first direction. The closed portion has a closed end that is received in a second pocket in the second cover. The pin extends through the coils.

In a further embodiment of any of the above, the first and second covers and the hinge posts provide an exterior aesthetic face generally in a plane. The terminal ends and the closed end are generally parallel to the plane and are respectively spaced at first and second distances orthogonal to the plane. The first and second distances are different than one another.

In a further embodiment of any of the above, the first distance is less than the second distance, and the closed portion is U-shaped.

In a further embodiment of any of the above, the inserting step includes inserting the pin through the hole in one lateral hinge portion, subsequently inserting the pin through a bore in one of the hinge posts, subsequently inserting the pin through a first lateral wall in the central hinge portion, subsequently inserting the pin through both coils, subsequently inserting the pin through a second lateral wall in the central hinge portion, subsequently inserting the pin through another bore in the other of the hinge posts, and subsequently inserting the pin into the other lateral hinge portion.

### BRIEF DESCRIPTION OF THE DRAWINGS

The disclosure can be further understood by reference to the following detailed description when considered in connection with the accompanying drawings wherein:

FIG. 1 is a schematic view of a tow vehicle and a trailer with connectors that cooperate with one another to provide an electrical connection between the vehicle and trailer.

FIG. 2 illustrates a perspective view of a combination trailer tow connector with first and second covers in a closed position.

FIG. 3A shows a 4-way connector when the first cover is in an open position.

FIG. 3B shows a 7-way connector when the second cover is in an open position.

FIGS. 4A-4C respectively depict perspective, top and side views of a disclosed spring.

FIG. 5 illustrates a top perspective view of the trailer tow connector shown in FIG. 2 before a hinge pin is inserted.

FIG. 6 is a cross-sectional view of the trailer tow connector shown in FIG. 2 and taken along line 6-6.

FIG. 7 is a cross-sectional view of the trailer tow connector shown in FIG. 2 and taken along line 7-7.

The embodiments, examples and alternatives of the preceding paragraphs, the claims, or the following description and drawings, including any of their various aspects or respective individual features, may be taken independently or in any combination. Features described in connection with one embodiment are applicable to all embodiments unless such features are incompatible.

### DETAILED DESCRIPTION

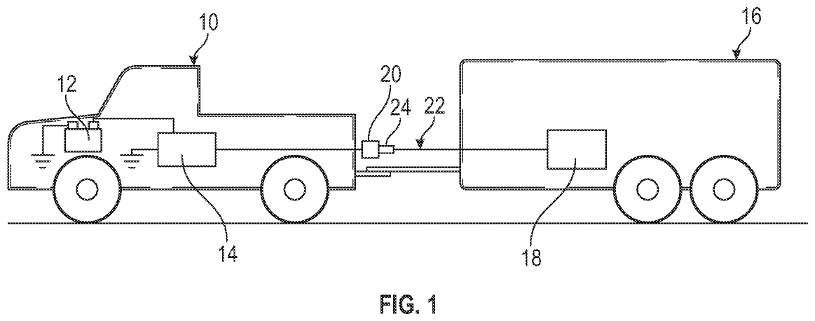

A tow vehicle 10 towing a trailer 16 is illustrated in FIG. 1. The vehicle 10 includes a power source 12 that supplies electrical power to a vehicle electrical system 14, which includes, for example, parking lights, brake lights, turn signals, and backup lights.

A trailer 16 includes a trailer electrical system 18 that includes, for example, parking lights, brake lights, turn signals, backup lights, and an electric brake system. The vehicle and the trailer electrical systems 14, 18 are electrically connected to one another by a trailer tow connector 20 on the tow vehicle 10 that interconnects to a trailer connector 24 on a wiring harness or pigtail 22 that is electrically connected to the trailer electrical system 18.

The electrical connection between the trailer tow connector 20 and the trailer connector 24 must be robust and reliable to ensure power to the trailer electrical system 18 during operation. This may be difficult due to corrosion in the connector's terminals. To this end, the disclosed trailer tow connector 20 provides an improved weather-tight arrangement.

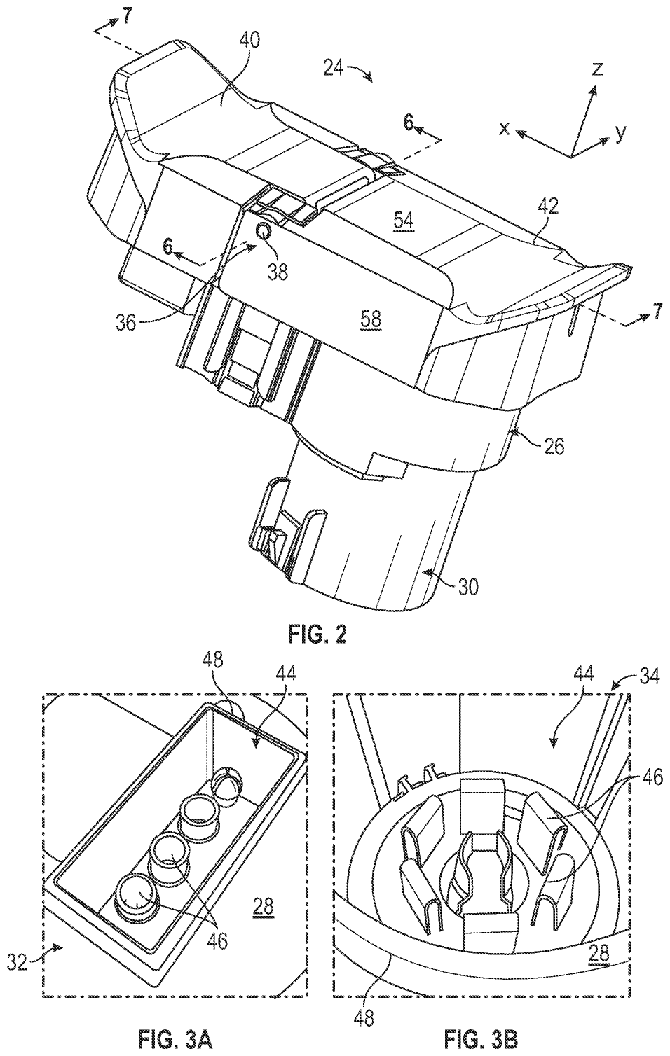

An example standard trailer tow connector 20 is shown in FIG. 2 and provides a combination 4-“way”/7-“way” (or “pole” or “terminal”) connector, which is illustrated in FIGS. 3A-3B. The example trailer tow connector 20 includes a plastic housing 26 providing first and second ends 28, 30 opposing one another. The first end 28 is arranged facing the exterior of the tow vehicle 10, typically near the vehicle's rear bumper. The second end 30 is connected to the vehicle electrical system 14 by a wiring harness, as is known. The housing 26 includes first and second bodies 32, 34 at the first end 28, which respectively provide the 4-way connector and the 7-way connector.

First and second covers 40, 42 are respectively arranged over the first and second bodies 32, 34 and are pivotal about a hinge 36 having a common pin 38 in the example. One or more springs bias the first and second covers 40, 42 to a closed position over the terminals 46 to provide a weather-type seal. FIG. 2 depicts both covers in a closed position, and FIGS. 3A and 3B illustrate the electrical connectors when the covers are in open positions, which exposes the connectors. It should be understood that this disclosure encompasses other types or configurations of trailer tow connectors than those described herein. That is, the first and second cover 40, 42 may be arranged over other types of electrical connectors.

As shown in FIGS. 3A and 3B, terminals 46 are arranged within a cavity 44 (one shown) in each of the first and second bodies 32, 34, and which receives a corresponding end the trailer connector 24. A wall 48, which circumscribes each of the cavities 44, may extend from the housing 26 toward its respective cover and seal against a rubber seal on an underside of the respective cover when in the closed position.

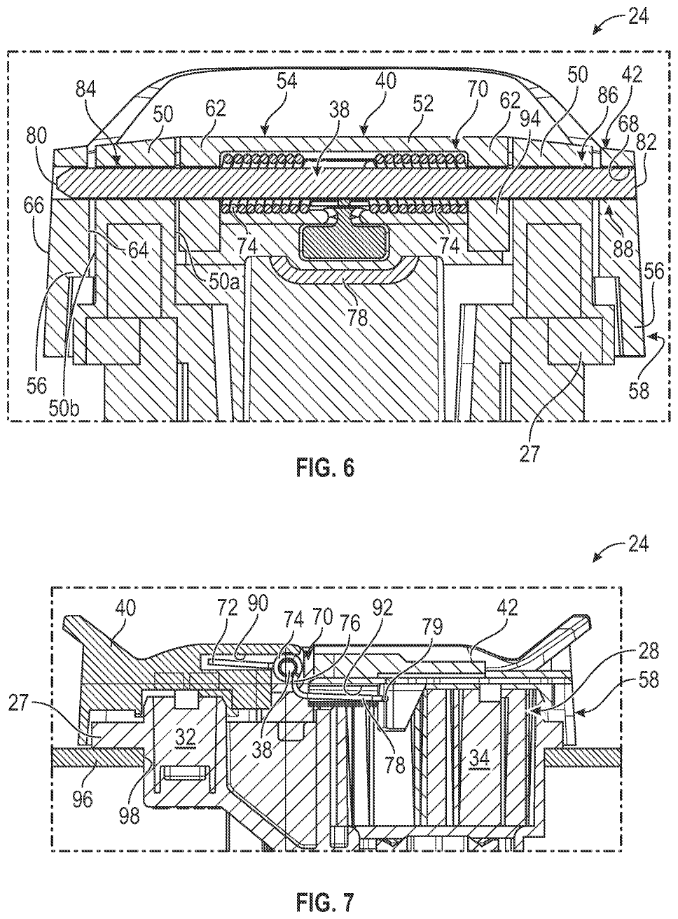

Referring to FIGS. 2 and 5-7, the housing 26 has laterally spaced apart (in a y-axis) hinge posts 50 that extend from the first end 28 in a z-direction. The first cover 40 has a central hinge portion 52 arranged between the hinge posts 50 in the lateral, y-axis. The second cover 42 has lateral hinge portions 56 arranged laterally outside hinge posts 50. Referring to FIGS. 5 and 6, each hinge post 50 has an inner side 50a, arranged laterally adjacent to side walls 62 of the central portion 52. Each hinge post 50 also has an outer side 50b arranged laterally adjacent to an inner face 64 of its nearest lateral hinge portion 56.

The lateral hinge portions 56 provide a portion (e.g., outer face 66) of an aesthetic perimeter 58, which provides not only a more attractive appearance, but also improved protection from weather by covering the sides of the hinge posts 50 and extending in close proximity to the vehicle's mounting structure. The outer face 66 conceals the outer sides 50b of the hinge posts 50, in the example, the entire outer sides 50b. The housing 26 provides an outer perimeter wall 27 (FIG. 7) that abuts a structure 96 (typically a vehicle bumper) with the trailer tow connector 20 in an installed position. The aesthetic perimeter 58 is provided by both the first and second covers 40, 42, and substantially conceals an outer perimeter wall 27 (e.g., more than 50% of the height of the outer perimeter wall 27 in the z-axis) with the first and second covers 40, 42 in a closed position (FIGS. 6 and 7). In the example, the aesthetic perimeter 58 is in close proximity to the structure when the covers are closed, e.g., less than 1 mm.

In the example, the first and second covers 40, 42 and the hinge posts 50 provide an exterior aesthetic face 54 substantially covering the first end 28 and its electrical connectors. The aesthetic perimeter 58 adjoins and circumscribes the exterior aesthetic face 54, which is generally planar (in x-y plane) in the example. There are upturned ends that serve as handles on each cover. If desired, the hinge posts 50 may be shortened and the first cover 40 or the second cover 42 extended to conceal the top of the hinge posts 50, which may further enhance weather-tightness.

A spring 70 is arranged beneath the first and second covers 40, 42. As best shown in FIG. 6, the pin 38 extends through a hole 68 in at least one lateral hinge portion 56 (in the example, both), through the hinge posts 50, the spring 70 and the central hinge portion 52. A center edge 60 of the central hinge portion 52 extends beyond the spring 70 in the x-y plane to substantially conceal it.

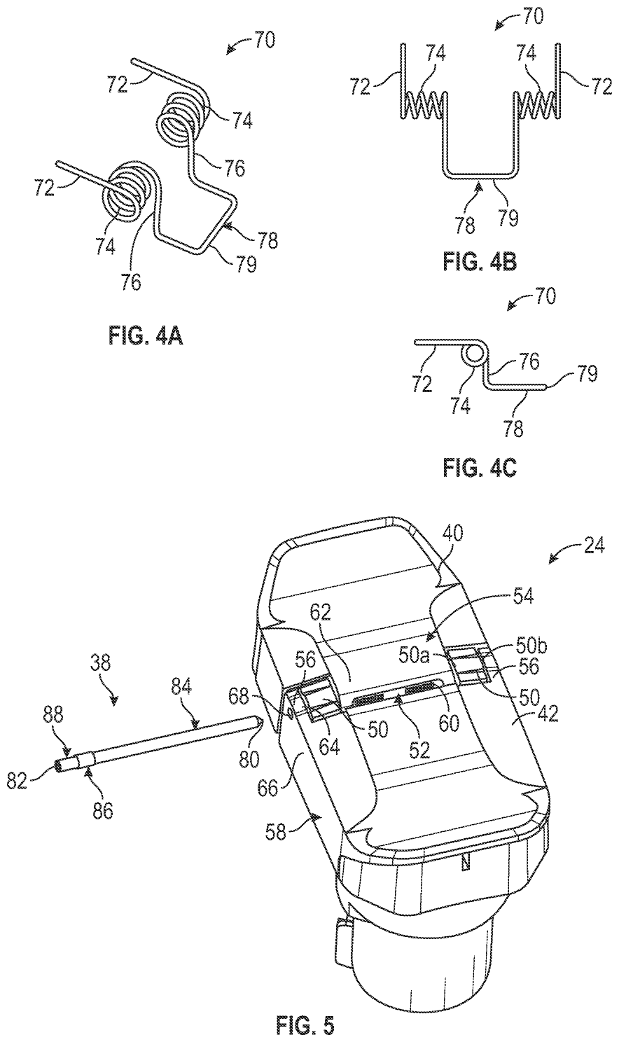

Referring to FIGS. 4A-4C, the spring 70 is provided by spaced apart coils 74 through which the pin 38 extends. A terminal end 72 extends from each coil 74 in the x-direction and is received in a first pocket 90 in the first cover 40, as shown in FIG. 7. A closed portion 78 joins the coils 74 and includes a portion extending in an opposite direction as the terminal ends 72. The closed portion 78, which is U-shaped, has a closed end 79 connected to the coils 74 by legs 76 and received in a second pocket 92 in the second cover 42. The terminal ends 72 and the closed end 79 are generally parallel to the x-y plane and are respectively spaced at first and second distances orthogonal to the x-y plane, the first and second distances are different than one another, and in one example, the first distance is less than the second distance.

Referring to FIGS. 5 and 6, the x-z plane is transverse to a longitudinal axis (y-axis) of the pin 38. As shown in FIGS. 4C and 7, the spring 70 is generally Z-shaped from a view toward the x-z plane. The pin 38 includes first, second and third sections 84, 86, 88 along the longitudinal axis of the pin 38. The second section 86 is longitudinally between the first and third sections 84, 88. The second section 86 has a diameter greater than that of the first and third sections 84, 88. When installed, the second section 86 is retained in a bore 94 of one of hinge posts 50 in an interference fit. The remainder of the pin 38 has a slight slip fit to facilitate assembly and ease of opening and closing the covers.

The trailer tow connector 20 is assembled by arranging the spring 70 relative to first and second covers 40, 42, which includes inserting the terminal ends 72 in the first pocket 90 and the closed end 79 in the second pocket 92. The first and second covers 40, 42 are respectively positioned over the first and second bodies 32, 34. The lateral hinge portions 56 are arranged laterally outside the hinge posts 50 concealing the outer sides 50b of the hinge posts 50. The pin 38 is inserted first through the hole 68 in one of the lateral hinge portions 54. In one example, the pin 38 includes a tapered end 80 (FIG. 5) that facilitates insertion. The pin 38 continues to be inserted through the bore 94 in one of the hinge posts 50, subsequently through a lateral wall 62 in the central hinge portion 52, subsequently through both coils 74, subsequently through another lateral wall 62, subsequently through another bore 94 in the other of the hinge posts 50, and finally into the other lateral hinge portion 54. A second end 82 of the pin 38 is generally flush with the aesthetic perimeter 58 when fully installed.

During vehicle assembly or aftermarket installation, a structure 96, such as a bumper, has an aperture 98 that receives the housing 26. The first end 28 with its supported first and second covers 40, 42 are arranged on a first side (outer, exterior side) of the structure 96. The aesthetic perimeter 58 provides an outermost perimeter of the trailer tow connector 20 around an entire periphery of the trailer tow connector 20 on the first side. Of course, there may be a small interruption in the aesthetic perimeter 58 wherein the first and second covers 40, 42 are adjacent one another. The second end 30 is arranged on a second side of the structure 96 where it connects to the vehicle electrical system 14, i.e., the wiring harness of the vehicle.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A trailer tow connector for a vehicle used in towing a trailer, comprising:
a housing having first and second bodies respectively providing first and second electrical connections, wherein the housing has laterally spaced apart hinge posts;
a spring arranged relative to first and second covers, wherein the first cover has a central hinge portion, and the second cover has lateral hinge portions, the first and second covers respectively over the first and second bodies, wherein lateral hinge portions are arranged laterally outside the hinge posts, and the lateral hinge portions provide a portion of an aesthetic perimeter, the portion concealing outer sides of the hinge posts; and
a pin extending through a hole in at least one lateral hinge portion, and through the central hinge portion, the hinge posts and the spring.

2. The trailer tow connector of claim 1, wherein the housing provides an outer perimeter wall configured to abut a structure with the trailer tow connector in an installed position, the aesthetic perimeter provided by the first and second covers, the aesthetic perimeter substantially concealing the outer perimeter wall with the first and second covers in a closed position.

3. The trailer tow connector of claim 1, wherein the first and second covers and the hinge posts provide an exterior aesthetic face substantially covering the spring, the aesthetic perimeter provided by the first and second covers and circumscribing the exterior aesthetic face.

4. The trailer tow connector of claim 1, wherein the spring is provided by spaced apart coils, a terminal end extending from each coil in a first direction and received in a first pocket in the first cover, and a closed portion joining the coils and extending in a second direction opposition the first direction, the closed portion having a closed end received in a second pocket in the second cover, the pin extending through the coils.

5. The trailer tow connector of claim 4, wherein the first and second covers and the hinge posts provide an exterior aesthetic face generally in a plane, the terminal ends and the closed end are generally parallel to the plane and are respectively spaced at first and second distances orthogonal to the plane, the first and second distances are different than one another.

6. The trailer tow connector of claim 5, wherein the first distance is less than the second distance, and the closed portion is U-shaped.

7. The trailer tow connector of claim 5, comprising a plane transverse to a longitudinal axis of the pin, and the spring is generally Z-shaped from a view toward the plane.

8. The trailer tow connector of claim 1, wherein the first electrical connection is a 4-pin connector, and the second electrical connection is a 7-pin connector.

9. The trailer tow connector of claim 1, wherein the pin includes first, second and third sections along a longitudinal axis of the pin, the second section longitudinally between the first and third sections, wherein the second section has a diameter greater than that of the first and third sections, the second section retained in the hole of the at least one lateral hinge portion in an interference fit.

10. A vehicle including the trailer tow connector of claim 2, comprising a structure having an aperture receiving the housing, the housing having a first end on a first side of the structure and including the first and second bodies, the aesthetic perimeter providing an outermost perimeter of the trailer tow connector around an entire periphery of the trailer tow connector on the first side.

11. The vehicle of claim 10, wherein the housing has a second end opposite the first end and arranged on a second side of the structure opposite the first side, the second end providing an electrical connector connected to a wiring harness of the vehicle.

12. A method of assembling a trailer tow connector, comprising:
providing a housing having first and second bodies respectively providing first and second electrical connections, wherein the housing has laterally spaced apart hinge posts;
arranging a spring relative to first and second covers, wherein the first cover has a central hinge portion, and the second cover has lateral hinge portions;
positioning the first and second covers respectively over the first and second bodies, wherein lateral hinge portions are arranged laterally outside the hinge posts, and the lateral hinge portions provide a portion of an aesthetic perimeter, the portion concealing outer sides of the hinge posts; and
inserting a pin through a hole in at least one lateral hinge portion, and the inserting step includes inserting the pin through the central hinge portion, the hinge posts and the spring.

13. The method of claim 12, wherein the housing provides an outer perimeter wall configured to abut a structure with the trailer tow connector in an installed position, the aesthetic perimeter provided by the first and second covers, the aesthetic perimeter substantially concealing the outer perimeter wall with the first and second covers in a closed position.

14. The method of claim 12, wherein the first and second covers and the hinge posts provide an exterior aesthetic face substantially covering the spring, the aesthetic perimeter provided by the first and second covers and circumscribing the exterior aesthetic face.

15. The method of claim 12, wherein the spring is provided by spaced apart coils, a terminal end extending from each coil in a first direction and received in a first pocket in the first cover, and a closed portion joining the coils and extending in a second direction opposition the first direction, the closed portion having a closed end received in a second pocket in the second cover, the pin extending through the coils.

16. The method of claim 15, wherein the first and second covers and the hinge posts provide an exterior aesthetic face generally in a plane, the terminal ends and the closed end are generally parallel to the plane and are respectively spaced at first and second distances orthogonal to the plane, the first and second distances are different than one another.

17. The method of claim 16, wherein the first distance is less than the second distance, and the closed portion is U-shaped.

18. The method of claim 15, wherein the inserting step comprises:
inserting the pin through the hole in one lateral hinge portion;
subsequently inserting the pin through a bore in one of the hinge posts;
subsequently inserting the pin through a first lateral wall in the central hinge portion;
subsequently inserting the pin through both coils;
subsequently inserting the pin through a second lateral wall in the central hinge portion;
subsequently inserting the pin through another bore in the other of the hinge posts; and
subsequently inserting the pin into the other lateral hinge portion.
